(19) United States
(12) Patent Application Publication
(10) Pub. No.: US 2024/0259722 A1
(43) Pub. Date: Aug. 1, 2024

(54) CHARGING BOX

(71) Applicant: GOERTEK TECHNOLOGY CO., LTD., Qingdao, Shandong (CN)

(72) Inventors: Xiaoyu GE, Qingdao, Shandong (CN); Zhongli CAO, Qingdao, Shandong (CN)

(21) Appl. No.: 18/561,056

(22) PCT Filed: Dec. 23, 2021
(86) PCT No.: PCT/CN2021/140652

§ 371 Date: Nov. 15, 2023

(30) Foreign Application Priority Data
Jun. 30, 2021 (CN) 202110744647.5

(51) Int. Cl. H04R 1/10; A45C 11/00; A45C 13/02; A45C 15/00

(52) U.S. Cl. CPC H04R 1/1025; A45C 11/00; A45C 13/02; A45C 15/00; A45C 2011/001

(57) ABSTRACT

Disclosed in a charging box including a lower housing and an upper housing slidably connected to a top opening of the lower housing, wherein the lower housing is provided with a lower inner housing therein, a top of the lower inner housing is opened and provided with an earphone slot, the lower inner housing is rotatably connected to the lower housing, and the upper housing is connected to the lower inner housing by a transmission structure, wherein during an opening movement of the upper housing, the transmission structure is configured to drive the lower inner housing to rotate, such that at least a part structure of the lower inner housing protrudes upward out of the top opening.

The disclosure claims a priority to Chinese Patent Application No. 202110744647.5 titled “CHARGING BOX” filed with China Patent Office on Jun. 30, 2021, the entire contents of which are incorporated herein by reference.

### TECHNICAL FIELD

The disclosure relates to a technical field of earphone accessories, and in particular to a charging box.

### DESCRIPTION OF RELATED ART

A bluetooth earphone is usually equipped with a charging box. At present, for a traditional charging box, the earphone is taken out from a lower housing after an upper housing is opened. However, the earphone is usually small, and the lower housing has a certain depth, if there is sweat on a user's fingers, it is not easy to take out the earphone from the lower housing smoothly, which affecting the user's experience.

Therefore, how to facilitate the taking out of the earphone is a technical problem needed to solve for those skilled in the art.

### SUMMARY

In view of the above, a purpose of the disclosure is to provide a charging box, from which the earphone is easy to be taken out.

To achieve the above purpose, the disclosure provides the following technical solutions:

A charging box includes a lower housing and an upper housing slidably connected to a top opening of the lower housing, wherein the lower housing is provided with a lower inner housing therein, a top part of the lower inner housing is opened and provided with an earphone slot, the lower inner housing is rotatably connected to the lower housing, and the upper housing is connected to the lower housing by a transmission structure, and wherein during an opening movement of the upper housing, the transmission structure is configured to drive the lower inner housing to rotate, such that at least a part structure of the lower inner housing protrudes upward out of the top opening.

Preferably, the transmission structure includes a connecting rod structure connected between the upper housing and the lower inner housing, and the upper housing pulls the lower inner housing to rotate by the connecting rod structure.

Preferably, the upper housing slides in a preset straight direction with respect to the lower housing, and during the opening movement of the upper housing, a part of a starting end of the lower inner housing in an opening movement direction of the upper housing gradually protrudes out of the top opening

Preferably, the transmission structure includes a connecting rod fixed to the upper housing; wherein the lower inner housing is provided with a control slide thereon, and the slide block on the connecting rod is slidably connected to the control slide, and wherein in a state that the upper housing closes the top opening, an angle is formed between the control slide and the opening movement direction of the upper housing, such that during the opening movement of the upper housing, the slide block slides relative to the control slide, and a pressure of the slide block on the control slide generates a torque with respect to a rotatory central line of the lower inner housing.

Preferably, in the state that the upper housing closes the top opening, the control slide gradually inclines towards a direction away from the upper housing in the opening movement direction of the upper housing.

Preferably, the lower inner housing is also provided with an initial slide matching with the control slide thereon, wherein in the state that the upper housing closes the top opening, the initial slide is parallel to the opening movement direction of the upper housing, and wherein during the opening movement of the upper housing, the slide block enters into the control slide after sliding in the initial slide.

Preferably, a top angle of an end of a bottom part of the lower inner housing in the opening movement direction of the upper housing is a rounded angle, and the rounded angle is centered on a rotatory central line of the lower inner housing.

Preferably, an upper housing elastic component is disposed between the lower housing and the upper housing, such that the upper housing has a tendency of closing movement, and/or wherein a lower inner housing elastic component is disposed between the lower inner housing and the lower housing, such that the lower inner housing has a movement tendency to retract to an inner of the lower housing.

Preferably, a cover plate is fixed and disposed in the lower housing, the cover plate and the lower housing enclose to form a mounting chamber, a battery and a PCB are disposed in the mounting chamber, and the lower inner housing is located outside of the mounting chamber.

Preferably, a projecting bracket is fixed and disposed in the lower housing, an upper housing slide is provided on a bottom surface of the upper housing, and the upper housing slide is slidably connected to the projecting bracket.

The disclosure discloses a charging box comprising a lower housing and an upper housing slidably connected to a top opening of the lower housing, wherein the lower housing is provided with a lower inner housing therein, a top of the lower inner housing is opened and provided with an earphone slot, the lower inner housing is rotatably connected to the lower housing, and the upper housing is connected to the lower inner housing by a transmission structure, wherein during an opening movement of the upper housing, the transmission structure is configured to drive the lower inner housing to rotate, such that at least a part structure of the lower inner housing protrudes upward out of the top opening.

During the opening movement of the upper housing, the lower inner housing is also driven to rotate an angle synchronously, at least a part structure of the lower inner housing protrudes upward out of the lower housing, and an earphone in the earphone slot protrudes upward out of the lower housing a certain distance accordingly, which can facilitate the taking out of the earphone.

### BRIEF DESCRIPTION OF DRAWINGS

In order to illustrate the technical solutions in the embodiments of the disclosure or the prior art more clearly, the drawings required to be used in the content of the embodiments or the prior art will be introduced briefly as following. Obviously, the drawings in the following description are merely embodiments of the disclosure, and for those of ordinary skill in the art, other drawings can also be obtained from the structure illustrated in these drawings without any creative effort.

FIG. 1 is a perspective view of the charging box in a closed state in a first embodiment provided by the disclosure;

FIG. 2 is a perspective view of the charging box in an opening state in the first embodiment provided by the disclosure;

FIG. 3 is a cross-section view of the charging box in the closed state in the first embodiment provided by the disclosure;

FIG. 4 is a cross-section view of the charging box in the opening state in the first embodiment provided by the disclosure;

FIG. 5 is a bottom view of an upper inner housing of the charging box in the first embodiment provided by the disclosure;

FIG. 6 is an analysis view of a sliding matching position of an upper housing and a lower housing in the closed state of the charging box in the first embodiment provided by the disclosure;

FIG. 7 is an analysis view of the sliding matching position of the upper housing and the lower housing in the opening state of the charging box in the first embodiment provided by the disclosure;

FIG. 8 is an explosion view of the charging box of the first embodiment provided by the disclosure;

FIG. 9 is a matching view of a connecting rod and a lower inner housing of the charging box of a second embodiment provided by the disclosure;

FIG. 10 is a matching view of a connecting rod and a lower inner housing of the charging box of a third embodiment provided by the disclosure; and

FIG. 11 is a matching view of a connecting rod and a lower inner housing of the charging box of a fourth embodiment provided by the disclosure.

### REFERENCE NUMBERS

battery 1;
upper housing 2, upper cover 21, upper inner housing 22, connecting rod 23, slide block 231, and upper housing slide 24;
lower housing 3, lower inner housing rotating shaft 31, lower inner housing elastic member 32, and top opening 33;
lower inner housing 4, earphone slot 41, initial slide 42, control slide 43, flat face 44, and rounded corner 45;
cover plate 5, vertical plate 51, and top plate 52;
projecting bracket 6;
upper housing elastic components 7; PCB 8; and
opening movement direction A of upper housing, and rotatory central line O.

### DETAILED DESCRIPTIONS

The technical solution in the embodiment of the disclosure will be described clearly and completely as following in combination with the drawings in the embodiment of the disclosure. Obviously, the described embodiment is only a part of the embodiments but not all of the embodiments of the disclosure. Based on the embodiments of the disclosure, all other embodiments obtained by those skilled in the art without making creative labor fall within the protection scope of the disclosure.

A main point of the disclosure is to provide a charging box, from which the earphone is easy to be taken out.

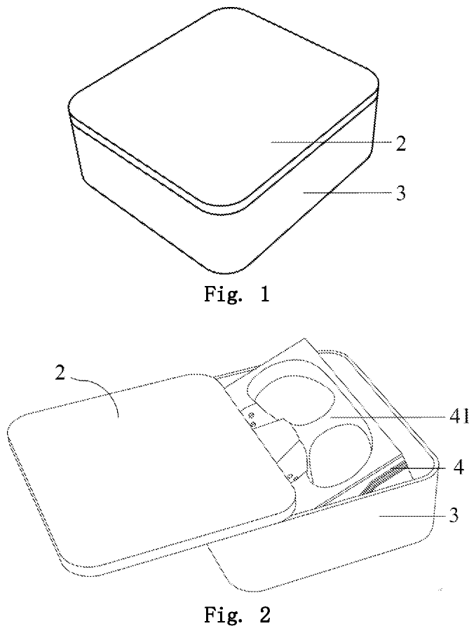

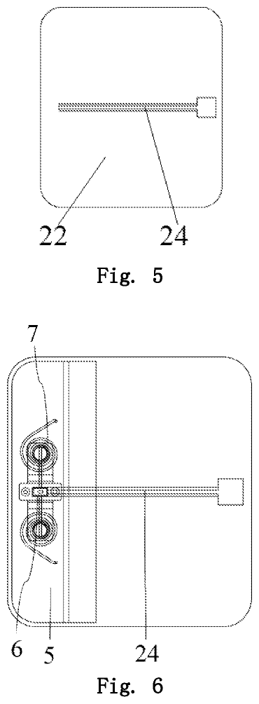

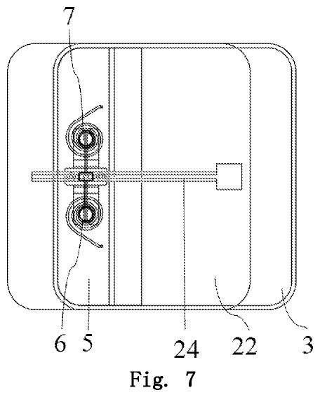

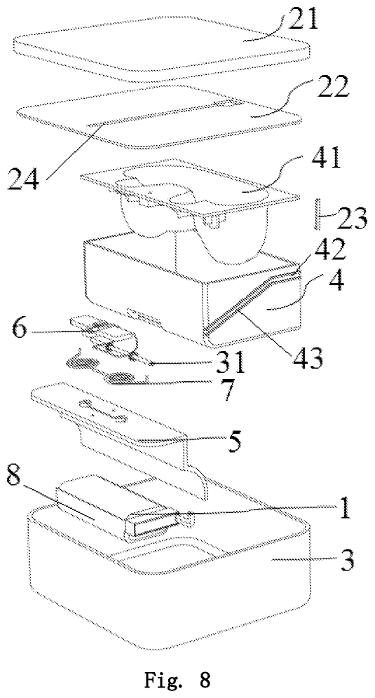

Please refer to FIGS. 1 to 8, a first embodiment of the charging box provided by the disclosure includes a lower housing 3 and an upper housing 2.

As shown in FIGS. 1 and 2, the upper housing 2 is slidably connected to a top opening 33 of the lower housing 3. The lower housing 3 is provided with a lower inner housing 4 therein, and a top of the lower inner housing 4 is opened and provided with an earphone slot 41, the earphone slot 41 is used to receive the earphone. Specifically, the lower inner housing 4 and the earphone slot 41 are separated with each other, and the lower inner housing 4 is disposed in the lower housing 3 after the earphone slot 41 is embedded and fixed to the lower inner housing 4. Of course, in other embodiments, the earphone slot 41 may also be machined directly on an inner surface of the lower inner housing 4.

Here, the sliding of the upper housing 2 on the lower housing 3 includes an opening movement and a closing movement in an opposite direction. By the opening movement of the upper housing 2, the top opening 33 is opened and the earphone slot 41 is exposed. As shown in FIG. 2, the charging box enters into the opening state. By the closing movement of the upper housing 2, the top opening 33 is closed, the earphone slot 41 is covered, and as shown in FIG. 1, the charging box enters into the closed state.

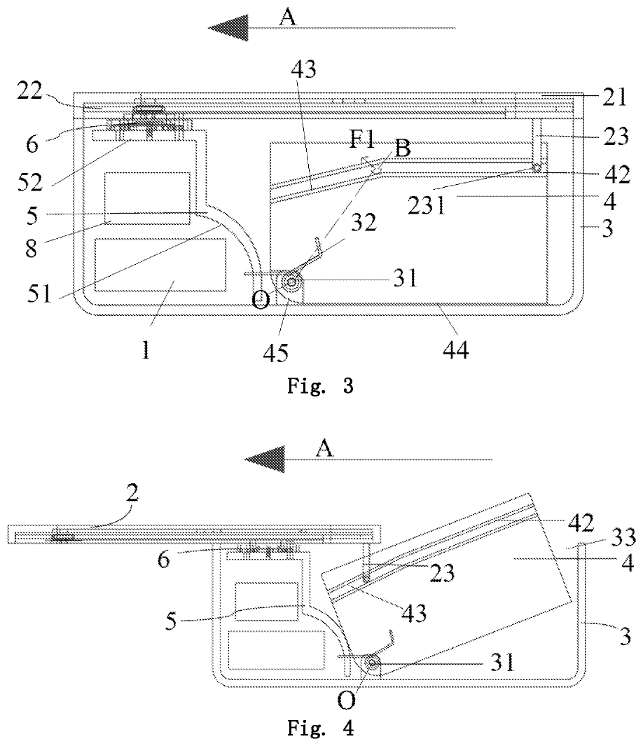

As shown in FIGS. 3 and 4, the lower inner housing 4 is rotatably connected to the lower housing 3. Specifically, a lower inner housing rotating shaft 31 is fixed and disposed in the lower housing 3, and the lower inner housing 4 is pivotably connected to the lower inner housing rotating shaft 31, and the axis line of the lower inner housing rotating shaft 31 is a rotatory central line O of the lower inner housing 4. The upper housing 2 is connected to the lower inner housing 4 by a transmission structure. During the opening movement of the upper housing 2, the transmission structure can drive the lower inner housing 4 to rotate, such that at least part structure of the lower inner housing 4 protrudes upward out of the top opening 33.

In this embodiment, during the opening movement of the upper housing 2, the lower inner housing 4 is also driven to rotate an angle synchronously, at least part structure of the lower inner housing 4 protrudes upward out of the lower housing 3, and the earphone in the earphone slot 41 protrudes upward out of the lower housing 3 a certain distance accordingly, which can facilitate the taking out of the earphone. In addition, the charging box can be specifically applied as a TWS charging box.

Further, as shown in FIG. 4, the transmission structure includes a connecting rod structure connected between the upper housing 2 and the lower inner housing 4, and the upper housing 2 pulls the lower inner housing 4 to rotate by the connecting rod structure. The linkage between the upper housing 2 and the lower inner housing 4 is realized by the connecting rod structure, thereby saving costs. Here, the connecting rod structure may include one or at least two connected rod bodies.

Further, as shown in FIGS. 3 and 4, the upper housing 2 is slidable in a preset straight direction with respect to the lower housing 3. In this embodiment, the rotatory central line O of the lower inner housing 4 rotating with respect to the upper housing 2 is perpendicular to an up and down direction and is perpendicular to the sliding direction of the upper housing 2. Of course, in other embodiments, the rotatory central line O may have a small inclination angle with respect to that in this embodiment.

Specifically, as shown in FIG. 4, an opening movement direction A of the upper housing 2 is a left movement direction as shown in FIG. 4. Along with the opening movement of upper housing 2, a right end of the top opening 33 of lower housing 3 gradually opens, and the lower inner housing 4 gradually protrudes out through the open part gradually expanded.

In addition, during the opening movement of the upper housing 2, a part of a starting end (a right end as shown in FIG. 4) of the lower inner housing 4 in the opening movement direction A of the upper housing 2 gradually protrudes out of the top opening 33. Then, with the continuous rotation of the lower inner housing 4, the part protruding out of the top opening 33 gradually increases. Taking the directions in FIG. 4 as an example, during the opening of the upper housing 2, the lower inner housing 4 rotates counterclockwise, and the lower inner housing 4 gradually enters into an inclined posture with a low left side and a high right side.

The sliding direction of the upper housing 2 is set as a straight line movement, so as to determine the position and the size to open the top opening 33 of the lower housing 3 during the opening of the upper housing 2, and so as to plan a path of the lower inner housing 4. At the same time, in the process of the opening, a part of the left end of the lower inner housing 4 directly below the upper housing 2 may be continuously lowered, which can reduce the risk of impact between the lower inner housing 4 and the upper housing 2.

Further, as shown in FIGS. 3 and 4, the connecting rod structure includes a connecting rod 23 fixed to the upper housing 2. The lower inner housing 4 is provided with a control slide 43 thereon. The connecting rod 23 is slidably connected to the control slide 43, in particular, a slide block 23 is fixed and disposed on the connecting rod, and the connecting rod 23 is slidably connected to the lower inner housing 4 by the slide block 23.

Here, the control slide 43 is disposed on an outer surface of the lower inner housing 4, to avoid occupying the inner space of the lower inner housing 4. In particular, the control slide 43 is disposed on a side surface of the part extending in the opening movement direction A of the upper housing in the outer surface of the lower inner housing 4. Preferably, the side surface of the part is a plane perpendicular to the rotatory central line O, so as to be machined. Of course, in other embodiments, the side surface of the part may also have other shapes, such as a curved surface. In addition, two control slides 43 are disposed opposite to each other on the lower inner housing 4. Of course, in other embodiments, the control slide 43 may also be disposed inside of the lower inner housing 4.

Here, as shown in FIG. 3, in a state that the upper housing 2 closes the top opening 33, an angle (that is, an angle greater than 0) is formed between the control slide and the opening movement direction A of the upper housing 2, such that during the opening movement of the upper housing 2, the slide block 231 on the connecting rod 23 slides relative to the control slide 43, and a pressure of slide block 231 on the connecting rod 23 to the control slide 43 generates a torque with respect to the rotatory central line O.

Here, within a preset stroke of the opening movement of the upper housing 2, the lower inner housing 4 rotates a preset angle, for example, 20°, synchronously. Here, the preset stroke may be equal to or less than a total stroke of the opening movement of the upper housing 2. When the upper housing 2 is within the preset stroke, the pressure of the slide block 231 on the connecting rod 23 to the control slide 43 always has a torque with respect to the rotatory central line O, such that the lower inner housing 4 rotates continuously, while the slide block 231 of the connecting rod 23 slides on the control slide 43, such that the upper housing 2 can slide normally.

Here, as shown in FIG. 3, the control slide 43 has a groove structure defined by an upper baffle wall and a lower baffle wall, and the slide block 231 is inserted in the control slide 43. In other embodiments, as shown in FIG. 10, the control slide 43 may also has a single baffle wall structure, and the slide block 231 slides while contactedly being fitted to the single baffle wall.

In this embodiment, the sliding fit of the slide block 231 and the slide is adopted to realize rotation control to the lower inner housing 4 to facilitate machining.

Further, as shown in FIG. 3, in the state that the upper housing 2 closes the top opening 33, the control slide 43 gradually inclines in the opening movement direction A of the upper housing 2 away from the upper housing 2. The direction as shown in FIG. 3 is inclined downward, which facilitates the machining of the control slide 43. Preferably, the control slide 43 is a straight slide.

Specifically, in the direction as shown in FIG. 3, the control slide 43 is inclined in a direction with a low left side and a high right side. With the opening movement of the upper housing 2, when the slide block 231 moves to a right end B of the control slide 43, the slide 231 generates a pushing force to left on the control slide 43. A component force F1 of the pushing force forms a torque F1×OB with respect to the rotatory central line O of the lower inner housing 4, such that the slide block 231 on the connecting rod 23 start to push the lower inner housing 4 until the lower inner housing 4 rotates to the state as shown in FIG. 4.

Further, as shown in FIG. 3, the lower inner housing 4 is also provided with an initial slide 42 matching with the control slide 43 thereon. In the state that the upper housing 2 closes the top opening 33, the initial slide 42 is parallel to the opening movement direction A of the upper housing 2. During the opening movement of the upper housing 2, the slide block 231 on the connecting rod 23 enters into the control slide 43 after sliding on the initial slide 42, such that after the upper housing 2 opens the top opening 33 for a certain area, the lower inner housing 4 starts to rotate, which can reduce the risk of impact between the upper housing 2 and the lower inner housing 4. In addition, the detailed structure of the initial slide 42 may refer to that of the control slide 43.

Of course, in other embodiments, the transmission structure may also be configured as a gear assembly, and correspondingly, the rotatory central line O of the lower inner housing 4 parallel to the sliding direction of the upper housing 2 may be realized according to directions of an input shaft and an output shaft of the gear assembly. In addition, the upper housing 2 may perform a curved movement on the lower housing 3. In addition, when the transmission structure is provided as a connecting rod structure, the connecting rod structure may include a connecting rod mechanism consist of two rotatably connected rod bodies, wherein two free ends of the connecting rod mechanism are rotatably connected to the lower inner housing 4 and the upper housing 2 respectively, and the pulling of the upper inner housing 22 may be achieved by change in positions of the rod bodies in the connecting rod mechanism when the upper housing 2 slides.

Further, a top angle of an end of a bottom part (corresponding to a left end in FIG. 3) of the lower inner housing 4 in the opening movement direction A of the upper housing 2 is a rounded angle 45, and the rounded angle 45 is centered on the rotatory central line O. Based on the setting of rounded angle 45, an avoidance space may be provided for the rotation of the lower inner housing 4. Accordingly, as shown in FIG. 3, along the opening movement direction A of the upper housing 2, a flat face 44 and the rounded angle 45 are docked sequentially at the bottom end of the lower inner housing 4. Thus, even in a closed state, the flat face 44 can come into a close contact with an inner bottom surface of the lower housing 3, and the lower inner housing 4 can rotate normally, which facilitate to realize the miniaturization of the charging box.

Further, as shown in FIGS. 3 and 6, an upper housing elastic component 7, such as a coiling spring, is disposed between the lower housing 3 and the upper housing 2, such that the upper housing 2 has a tendency of closing movement. In addition, a lower inner housing elastic component 32 is disposed between the lower inner housing 4 and the lower housing 3, for example, a torsion spring is disposed on a lower inner housing rotating shaft 31, such that the lower inner housing 4 has a movement tendency to retract to an inner of the lower housing 3. By setting the upper housing elastic component 7 and the lower inner housing elastic component 32, an automatic closing movement of the upper housing 2 can be realized. Of course, in other embodiments, only one of the upper housing elastic component 7 or the lower inner housing elastic component 32 may be disposed.

Further, as shown in FIG. 3, a cover plate 5 is fixed and disposed in the lower housing 3, and the cover plate 5 and the lower housing enclose to form a mounting chamber, a battery 1 and a PCB 8 are disposed in the mounting chamber, and the lower inner housing 4 is located outside of the mounting chamber. An internal space of the lower housing 3 is divided by the cover plate 5, which can prevent dust and protect the battery 1 and the PCB 8.

Further, as shown in FIG. 4 to FIG. 7, a projecting bracket 6 is fixed and disposed in the lower housing 3, an upper housing slide 24 is provided on a bottom surface of the upper housing 2, and the upper housing slide 24 is slidably connected to the projecting bracket 6.

Preferably, the cover plate 5 is an L-shaped plate including a vertical plate 51 and a top plate 52 fixed at a top end of the vertical plate 51. The vertical plate 51 includes a curved surface, and the lower inner housing 4 can move by attaching the curved surface during a process that the lower inner housing 4 rotates to protrude out of the top opening 33 of the lower housing 3, so as to improve stability of the rotation of the lower inner housing 4. In addition, the projecting bracket 6 is fixed on the top plate 52.

Specifically, the upper housing 2 includes an upper inner housing 22 and an upper cover 21 fixed and covered on the upper inner housing 22, and the upper housing slide 24 penetrates the upper inner housing 22 for easy machining.

Specifically, the projecting bracket 6 is engaged with the upper housing 2, to limit the upper housing 2 in the up and down direction, so as to prevent the upper housing 2 from escaping from the lower housing 3 in the up and down direction.

In this embodiment, the projecting bracket 6 is extended into the upper housing slide 24, and when the upper housing 2 slides, the upper housing slide 24 slides relative to the projecting bracket 6, which can limit the sliding direction of the upper housing 2 and improve the sliding stability of the upper housing 2.

The working principle of the charging box in this embodiment is: starting from the closed state, the upper housing 2 slides in the opening movement direction A, and drive the slide block 231 of the connecting rod 23 to slide in the initial slide 42, and then the slide block 231 enters into the control slide 43 and drives the lower inner housing 4 to rotate, and when the upper cover 21 slides to open to a certain distance, the lower inner housing 4 may be lifted at a certain angle, and a part structure of the lower inner housing 4 protrudes upward out of the top opening 33 of the lower housing 3, so as to facilitate the taking out of the earphone; further, the upper housing 2 is pushed in a reverse direction, the lower inner housing 4 rotates back into the inner of the lower housing 3, and the charging box retracts to the closed state.

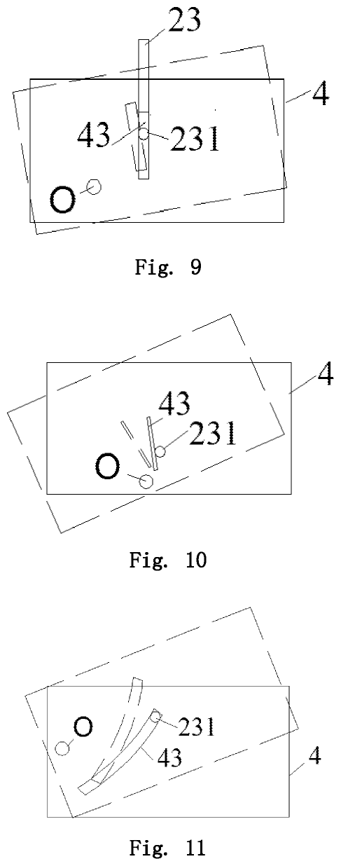

Of course, in other embodiments, the control slide 43 may also be provided in other manners. As shown in FIG. 9, in a second embodiment, the control slide 43 is parallel to the upper and lower direction in the closed state as shown by the solid line. With the opening movement of the upper housing 2, the lower inner housing 4 can rotate to a position as shown by the dashed line. Alternatively, in a third embodiment, the control slide 43 gradually approaches the upper housing 2 in the opening movement direction A of the upper housing 2 in the closed state as shown by the solid line. With the opening movement of the upper housing 2, the lower inner housing 4 can rotate to a position as shown by the dashed line. Alternatively, in a fourth embodiment, as shown in FIG. 11, the control slide 43 may also be an curved slide. With the opening movement of the upper housing 2, the lower inner housing 4 may be transferred from the solid line position to the dashed line position.

It should be noted that when a component is said to be “fixed” to another component, it can be directly on the other component or another component may also be between the two components. When a component is considered to be “connected” to another component, it may be directly connected to the other component or a component sandwiched between may also be existed.

Orientation or position relationships indicated by terms “center”, “left”, “right”, “vertical”, “up”, “down”, “horizontal”, “inside”, “outside”, etc., are based on the orientation or position relationships as shown in the drawings, only for facilitating and simplifying the description of the disclosure, not indicating or implying that the device or the element referred to must have a particular direction or be constructed and operated in a particular direction, and therefore cannot be understood as a limitation to the disclosure. In addition, terms “first”, “second” and “third” are only used for descriptive purposes and cannot understood as indicating or implying relative importance or as implicitly indicating the quantity of the technical features indicated.

Unless otherwise defined, all technical and scientific terms used herein have the same meaning as would normally be understood by those skilled in the technical field belonging to the disclosure. The terms used herein in the description of the disclosure are for the purpose of only describing specific embodiments and are not intended to limit the disclosure.

Various embodiments in the description are described in a progressive manner, and each embodiment focuses on its differences from other embodiments. The same and similar parts of each embodiment can be referred to each other.

The charging box provided by the disclosure has been described in detail above. Specific examples are used herein to describe the principle and embodiment of the disclosure. The above description for the embodiments is only used for help understanding the method of the disclosure and core ideas thereof. It should be pointed out that for those skilled in the art, without departing from the principle of the disclosure, several improvements and modifications can also be made to the disclosure, and these improvements and modifications also fall within the protection scope of the claims of the disclosure.

1. A charging box comprising a lower housing and an upper housing slidably connected to a top opening of the lower housing,
wherein the lower housing is provided with a lower inner housing therein, a top part of the lower inner housing is opened and provided with an earphone slot, the lower inner housing is rotatably connected to the lower housing, and the upper housing is connected to the lower inner housing by a transmission structure, and
wherein the transmission structure is configured to, during an opening movement of the upper housing, drive the lower inner housing to rotate, such that at least a part structure of the lower inner housing protrudes upward out of the top opening.

2. The charging box according to claim 1, wherein the transmission structure comprises a connecting rod structure connected between the upper housing and the lower inner housing, and the upper housing pulls the lower inner housing to rotate by the connecting rod structure.

3. The charging box according to claim 1, wherein the upper housing is slidable in a preset straight direction with respect to the lower housing, and during the opening movement of the upper housing, a part of a starting end of the lower inner housing in an opening movement direction of the upper housing gradually protrudes out of the top opening.

4. The charging box according to claim 3, wherein the transmission structure comprises a connecting rod fixed to the upper housing,
wherein the lower inner housing is provided with a control slide thereon, and a slide block on the connecting rod is slidably connected to the control slide, and
wherein in a state that the upper housing closes the top opening, an angle is formed between the control slide and the opening movement direction of the upper housing, such that during the opening movement of the upper housing, the slide block slides relative to the control slide, and a pressure of the slide block on the control slide generates a torque with respect to a rotatory central line of the lower inner housing.

5. The charging box according to claim 4, wherein in the state that the upper housing closes the top opening, the control slide gradually inclines towards a direction away from the upper housing in the opening movement direction of the upper housing.

6. The charging box according to claim 4, wherein the lower inner housing is also provided with an initial slide matching with the control slide thereon,
wherein in the state that the upper housing closes the top opening, the initial slide is parallel to the opening movement direction of the upper housing, and
wherein during the opening movement of the upper housing, the slide block enters into the control slide after sliding in the initial slide.

7. The charging box according to claim 3, wherein a top angle of an end of a bottom part of the lower inner housing in the opening movement direction of the upper housing is a rounded angle, and the rounded angle is centered on a rotatory central line of the lower inner housing.

8. The charging box according to claim 1, wherein an upper housing elastic component is disposed between the lower housing and the upper housing, such that the upper housing has a tendency of closing movement, and/or wherein a lower inner housing elastic component is disposed between the lower inner housing and the lower housing, such that the lower inner housing has a movement tendency to retract to an inner of the lower housing.

9. The charging box according to claim 1, wherein a cover plate is fixed and disposed in the lower housing, the cover plate and the lower housing enclose to form a mounting chamber, a battery and a PCB are disposed in the mounting chamber, and the lower inner housing is located outside of the mounting chamber.

10. The charging box according to claim 1, wherein a projecting bracket is fixed and disposed in the lower housing, an upper housing slide is provided on a bottom surface of the upper housing, and the upper housing slide is slidably connected to the projecting bracket.
